(19) United States
(12) Patent Application Publication
(10) Pub. No.: US 2025/0095109 A1
(43) Pub. Date: Mar. 20, 2025

(54) METHOD, DEVICE, AND EQUIPMENT FOR REMOVING GHOSTING BASED ON ELECTRONIC INK SCREEN AND STORAGE MEDIUM

(71) Applicant: Shenzhen Dawo Cloud Reading and Writing Technology Co., Ltd., Shenzhen (CN)

(72) Inventors: Qingyuan LIN, Shenzhen (CN); Junxi OU, Shenzhen (CN)

(73) Assignee: Shenzhen Dawo Cloud Reading and Writing Technology Co., Ltd., Shenzhen (CN)

(21) Appl. No.: 18/888,403

(22) Filed: Sep. 18, 2024

(30) Foreign Application Priority Data
Sep. 18, 2023 (CN) 202311205119.8

(51) Int. Cl. G06T 5/50; G06T 7/13; G06V 10/75

(52) U.S. Cl. CPC G06T 5/50; G06T 7/13; G06V 10/751; G06T 2207/20221

(57) ABSTRACT

Disclosed are a method, a device and an equipment for removing ghosting based on an electronic ink screen and a storage medium. The method includes: performing image mergence on a current frame binarization image of the electronic ink screen and a ghosting image of a previous frame binarization image of the electronic ink screen, and obtaining a current frame merged image containing ghosting position information of a previous frame image; performing a pixel comparison operation on a previous frame merged image and the current frame merged image, and obtaining index data; and outputting a target display image without the ghosting according to the index data.

### CROSS-REFERENCE TO RELATED APPLICATIONS

This application claims priority to Chinese Patent Application No. 202311205119.8, filed on Sep. 18, 2023. The disclosure of the above-mentioned application is incorporated herein by reference in its entirety.

### TECHNICAL FIELD

The present application relates to the technical field of electronic ink screen (E-ink screen for short), and in particular to a method for removing ghosting based on an electronic ink screen, a device for removing ghosting based on an electronic ink screen, an equipment for removing ghosting based on an electronic ink screen and a storage medium.

### BACKGROUND

The electronic ink screen is also known as the electronic paper display (EPD) technology. The structure of this screen consists of two substrates, which are coated with electronic ink composed of countless tiny transparent particles, and the ink consists of positively charged white particles and negatively charged black particles. Adding a positive charge to the two substrates, the black particles move up, the white particles sink, and the electronic ink screen will display black; on the contrary, adding a negative charge to the substrate, the white particles will move up, the black particles will sink, and the electronic ink screen will display white. At this time, removing the electricity, and the pattern can still remain unchanged on the screen for several months. At the same time, the electronic ink screen particles do not emit light, but only reflect natural light, so it can play a good “eye protection” role.

Based on these excellent characteristics of the electronic ink screen, it is often used in e-book readers, electronic ink screen tablets, educational tablets, office and learning tablets, and even displays, billboards and other scenarios. However, due to precision issues, the electric field control applied to a certain pixel in the screen may affect the surrounding particles, causing some particles to be affected and deviated when the electronic ink screen is refreshed, and the particles cannot move to the specified position, thereby forming a ghosting on the screen display.

In summary, how to automatically remove the ghosting when the electronic ink screen is refreshed has become an urgent problem to be solved in this field.

### SUMMARY

The main purpose of the present application is to provide a method for removing ghosting based on an electronic ink screen, a device for removing ghosting based on an electronic ink screen, an equipment for removing ghosting based on an electronic ink screen and a storage medium, which are intended to automatically remove the ghosting when the electronic ink screen is refreshed.

To achieve the above purpose, the present application provides a method for removing ghosting based on an electronic ink screen, including:
performing image mergence on a current frame binarization image of the electronic ink screen and a ghosting image of a previous frame binarization image of the electronic ink screen, and obtaining a current frame merged image containing ghosting position information of a previous frame image;
performing a pixel comparison operation on a previous frame merged image and the current frame merged image, and obtaining index data; and
outputting a target display image without the ghosting according to the index data.

In an embodiment, before the performing the image mergence on the current frame binarization image of the electronic ink screen and the ghosting image of the previous frame binarization image of the electronic ink screen, the method further includes:
obtaining a current frame image of the electronic ink screen and the previous frame binarization image of the electronic ink screen;
performing binarization processing on the current frame image to obtain the current frame binarization image; and
obtaining the ghosting image of the previous frame binarization image according to the previous frame binarization image and the current frame binarization image.

In an embodiment, the obtaining the ghosting image of the previous frame binarization image according to the previous frame binarization image and the current frame binarization image includes:
comparing gray scale changes of each pixel in the previous frame binarization image and gray scale changes of each pixel in the current frame binarization image; the gray scale changes includes a first change from black to white and a second change from white to black;
extracting a changed pixel point that have undergone the first change in the previous frame binarization image or the second change in the previous frame binarization image to generate a changed pixel image according to the changed pixel points; and
performing edge detection on the changed pixel image to obtain the ghosting image of the previous frame binarization image; a pixel point that has undergone the first change in the ghosting image are marked as a first gray scale, and a pixel point that has undergone the second change in the ghosting image are marked as a second gray scale.

In an embodiment, the electronic ink screen includes a display module, and the outputting the target display image without the ghosting according to the index data includes:
searching for a waveform sequence corresponding to the index data from a preset index data table; and
controlling a voltage of the display module to change according to the waveform sequence, so as to output the target display image without ghosting by the display module.

In an embodiment, before the searching for the waveform sequence corresponding to the index data from the preset index data table, the method further includes:
obtaining combined data of one-to-one matching of multiple index data and multiple waveform sequences by voltage level testing; and
establishing an index data table in the electronic ink screen according to the combined data.

In an embodiment, the performing the image mergence on the current frame binarization image of the electronic ink screen and the ghosting image of the previous frame binarization image of the electronic ink screen includes:
taking the current frame binarization image of the electronic ink screen and the ghosting image of the previous frame binarization image as an input image of a blending layer merging algorithm to perform the image mergence.

In an embodiment, after the outputting the target display image without the ghosting according to the index data, the method further includes:
applying a special waveform sequence according to a received reconstruction instruction; and
controlling a voltage of a display module of the electronic ink screen to change according to the special waveform sequence, so as to completely remove a ghosting of an entire screen.

The present application further provides a device for removing ghosting based on an electronic ink screen, including:
an image merging module, configured to perform image mergence on a current frame binarization image of the electronic ink screen and a ghosting image of a previous frame binarization image of the electronic ink screen, and obtain a current frame merged image containing ghosting position information of a previous frame image;
an index module, configured to perform a pixel comparison operation on a previous frame merged image and the current frame merged image, and obtain index data; and
an output module, configured to output a target display image without the ghosting according to the index data.

The present application further provides a terminal equipment, including: at least one processor; a memory connected to the at least one processor in communication; and the memory stores an instruction executable by the at least one processor, the instruction is executed by the at least one processor to cause the at least one processor to execute the method for removing the ghosting based on the electronic ink screen as described above.

The present application further provides a storage medium, the storage medium is a non-transitory computer-readable storage medium storing a program for implementing a method for removing ghosting based on an electronic ink screen, and the program for implementing the method for removing the ghosting based on the electronic ink screen is executed by a processor to implement the method for removing the ghosting based on the electronic ink screen as described above.

The present application further provides a computer program product including a computer program, and when the computer program is executed by a processor, the method for removing the ghosting based on the electronic ink screen as described above is implemented.

The present application provides a method, a device and an equipment for removing ghosting based on an electronic ink screen and a storage medium. By performing image mergence on a current frame binarization image of the electronic ink screen and a ghosting image of a previous frame binarization image of the electronic ink screen, the method obtains a current frame merged image containing ghosting position information of a previous frame image. Then, performing a pixel comparison operation on a previous frame merged image and the current frame merged image, and obtaining index data. Finally, outputting a target display image without the ghosting according to the index data.

By marking the ghosting of an image in advance, the present application performs a pixel comparison operation on the previous frame merged image and the current frame merged image containing the position information of the ghosting of the image, obtains the index data of the current frame image without the ghosting, and outputs the target display image without the ghosting according to the index data, thereby avoiding the problem of the ghosting being too heavy after the electronic ink screen is refreshed, and achieving the effect of automatically removing the ghosting when the electronic ink screen is refreshed.

### BRIEF DESCRIPTION OF THE DRAWINGS

The accompanying drawings herein are incorporated into the specification and constitute a part of the specification, showing embodiments consistent with the present application, and together with the specification, are used to explain the principles of the present application.

In order to explain the embodiments of the present application or the technical solutions in the prior art more clearly, the accompanying drawings needed to be used in the description of the embodiments or the prior art will be briefly introduced below. Obviously, other accompanying drawings can further be obtained based on these accompanying drawings without exerting creative efforts for those skilled in the art.

FIG. 1 is a schematic flow chart of a method for removing ghosting based on an electronic ink screen according to an embodiment of the present application.

FIG. 2 is a schematic flow chart of a method for removing ghosting based on an electronic ink screen according to an embodiment of the present application.

FIG. 3 is a schematic scene chart of the method for removing the ghosting based on the electronic ink screen according to an embodiment of the present application.

FIG. 4 is a schematic view of a module structure of a device for removing ghosting based on an electronic ink screen according to the present application.

FIG. 5 is a schematic view of an equipment structure of a hardware operating environment involved in a method for removing ghosting based on an electronic ink screen according to an embodiment of the present application.

FIG. 6 is a schematic flow chart of a method for removing ghosting based on an electronic ink screen according to a first embodiment of the present application.

FIG. 7 is a schematic flow chart of a method for removing ghosting based on an electronic ink screen according to the first embodiment of the present application.

FIG. 8 is a schematic flow chart of a method for removing ghosting based on an electronic ink screen according to a second embodiment of the present application.

FIG. 9 is a schematic flow chart of a method for removing ghosting based on an electronic ink screen according to the second embodiment of the present application.

FIG. 10 is a schematic flow chart of a method for removing ghosting based on an electronic ink screen according to the second embodiment of the present application.

FIG. 11 is a schematic flow chart of a method for removing ghosting based on an electronic ink screen according to the second embodiment of the present application.

The purpose, functional features and advantages of the present application will be further explained in conjunction with the embodiments and with reference to the accompanying drawings.

### DETAILED DESCRIPTION OF THE EMBODIMENTS

In order to make the purpose, technical solutions and advantages of the present application clearer, the technical solutions in the embodiments of the present application will be clearly and completely described below in conjunction with the accompanying drawings in the embodiments of the present application. Obviously, the described embodiments are only some of the embodiments of the present application, but not all of the embodiments. Based on the embodiments of the present application, all other embodiments obtained by those skilled in the art without any creative work fall within the scope of the present application.

The electronic ink screen is also known as the electronic paper display (EPD) technology. The structure of this screen consists of two substrates, which are coated with electronic ink composed of countless tiny transparent particles, and the ink consists of positively charged white particles and negatively charged black particles. Adding a positive charge to the two substrates, the black particles move up, the white particles sink, and the electronic ink screen will display black; on the contrary, adding a negative charge to the substrate, the white particles will move up, the black particles will sink, and the electronic ink screen will display white. At this time, removing the electricity of the two poles, and the pattern can still remain unchanged on the screen for several months. At the same time, the electronic ink screen particles do not emit light, but only reflect natural light, so it can play a good “eye protection” role.

In the process of actually controlling the electronic ink screen to display, due to various reasons, the movement of the color particles will have errors, and will not move to the specified position accurately as the user wishes, which will bring about the ghosting phenomenon common in the electronic ink screen. For example, since the electronic ink screen is composed of multiple closely arranged ink capsules, there will be a problem of electric field crosstalk between adjacent ink capsules, that is, the electric field formed by the two electrodes designed for one ink capsule will not completely constrain the color particles in this ink capsule. When the color particles in a certain ink capsule move under the action of the electric field, a weak electric field will also appear in the adjacent ink capsule, and its color particles will move unexpectedly. Therefore, when the electronic ink screen displays an image, the display control electric field generated according to the image component to be displayed will actually affect a range larger than the expected range corresponding to the image to be displayed; when the screen needs to be refreshed and the original image component is eliminated, the outline of the eliminated image component (the part with increased display area) will remain on the screen, and an unexpected ghosting will appear.

In summary, how to automatically remove the ghosting when the electronic ink screen is refreshed has become an urgent problem to be solved in this field.

Based on this, the present application proposes a method for removing ghosting based on an electronic ink screen. In this embodiment, for ease of understanding and explanation, the electronic ink screen equipment is regarded as the direct execution subject in this embodiment to explain the method for removing the ghosting based on the electronic ink screen in the present application.

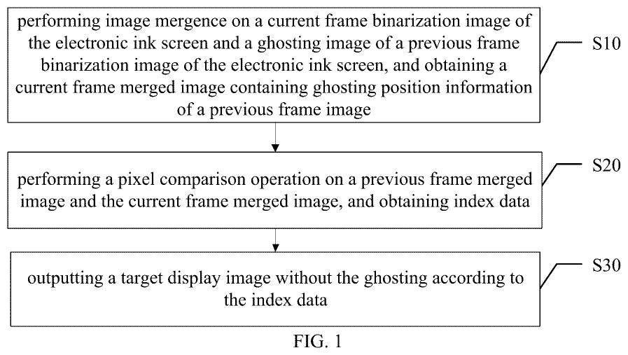

Referring to FIG. 1, the method for removing the ghosting based on the electronic ink screen includes:

Step S10, performing image mergence on a current frame binarization image of the electronic ink screen and a ghosting image of a previous frame binarization image of the electronic ink screen, and obtaining a current frame merged image containing ghosting position information of a previous frame image.

For video stream or image stream data, the system of the electronic ink screen sends the image data to be displayed to the display equipment one frame by one frame. In order to perform normalization processing, all images need to be performed binarization processing, and converting the image to be displayed from color to black and white.

In this embodiment, the electronic ink screen equipment has obtained the current frame binarization image and the previous frame binarization image after respective binarization processing, and further performs image processing on the previous frame binarization image to obtain the ghosting image of the previous frame binarization image. The ghosting image is the ghosting that may be generated when the electronic ink screen equipment refreshes to the current frame image. The electronic ink screen equipment performs image mergence on the ghosting image and the current frame binarization image, the merged and obtained current frame merged image includes both the ghosting position information of a previous frame image and the current frame image information.

It should be noted that, in this embodiment, the previous frame binarization image is the binarization image corresponding to the image currently actually displayed on the display interface of the electronic ink screen equipment, and the current frame binarization image is the binarization image corresponding to the image that the electronic ink screen equipment will display on the display interface.

Step S20, performing a pixel comparison operation on a previous frame merged image and the current frame merged image, and obtaining index data.

In this embodiment, the previous frame merged image is the image currently actually displayed on the display interface of the electronic ink screen equipment, and the current frame merged image is the image to be displayed on the display interface. The electronic ink screen equipment performs a pixel comparison operation on the previous frame merged image and the current frame merged image, and obtains the gray value change of each pixel point in the two images. The gray value change data of each pixel point in the two images is the index data.

For example, at the (x, y) coordinate, the gray value of the previous frame binarization image is G0, and the gray value of the current frame merged image is G1, then the index data at the (x, y) coordinate can be obtained as index=(G0&0xf0)|(G1>>4).

Step S30, outputting a target display image without the ghosting according to the index data.

The electronic ink screen equipment controls the pixel point to reach the expected pixel gray value by sending a drive pulse to the display controller configured by itself. The drive pulse includes a change signal of the voltage difference (driving voltage) between the electrodes on both sides of the ink capsule, and the duration (represented in the form of a frame) of the change signal of the voltage difference between the electrodes on both sides of the ink capsule. The display controller controls the ink capsule according to the drive pulse to cause the pixel gray value to change.

In this embodiment, the electronic ink screen equipment determines a drive pulse of each pixel according to the index data, so that the display interface displays a target display image without a ghosting according to the determined drive pulse.

In this embodiment, the electronic ink screen equipment performs image mergence on the ghosting image of the previous frame binarization image and the current frame binarization image, and the merged and obtained current frame merged image includes both the ghosting position information of a previous frame image and the current frame image information. Then, the electronic ink screen equipment performs a pixel comparison operation on the previous frame merged image and the current frame merged image, and obtains the gray value change of each pixel point in the two images. The gray value change data of each pixel point in the two images is the index data. Finally, the electronic ink screen equipment determines the drive pulse of each pixel according to the index data, so that the display interface displays the target display image without the ghosting according to the determined drive pulse.

In this way, by marking the ghosting of an image in advance, this embodiment performs a pixel comparison operation on the previous frame merged image and the current frame merged image containing the position information of the ghosting of the image, obtains the index data of the current frame image without the ghosting, and outputs the target display image without the ghosting according to the index data, thereby avoiding the problem of the ghosting being too heavy after the electronic ink screen is refreshed, and achieving the effect of automatically removing the ghosting when the electronic ink screen is refreshed.

In a possible implementation, referring to FIG. 6, the above-described step S10: performing the image mergence on the current frame binarization image of the electronic ink screen and the ghosting image of the previous frame binarization image of the electronic ink screen, includes:

Step S101, taking the current frame binarization image of the electronic ink screen and the ghosting image of the previous frame binarization image as an input image of a blending layer merging algorithm to perform the image mergence.

In this embodiment, the electronic ink screen equipment includes an image processing module. The image processing module is preset with a blending layer merging algorithm, which basically does not increase the CPU (Central Processing Unit) resource loss of the electronic ink screen equipment, and does not reduce the refresh speed of the electronic ink screen equipment at the same time, so that the electronic ink screen equipment can automatically eliminate the ghosting without increasing resource loss and reducing speed, thereby improving the user experience.

The electronic ink screen equipment transmits a current frame binarization image and a ghosting image of a previous frame binarization image to the image processing module. The image processing module uses the two images as two input images of a blending layer merging algorithm (a kind of layer merging algorithm) and merges them into one image by the blending layer merging algorithm. The merged current frame merged image includes both the ghosting position information of the previous frame image and the current frame image information.

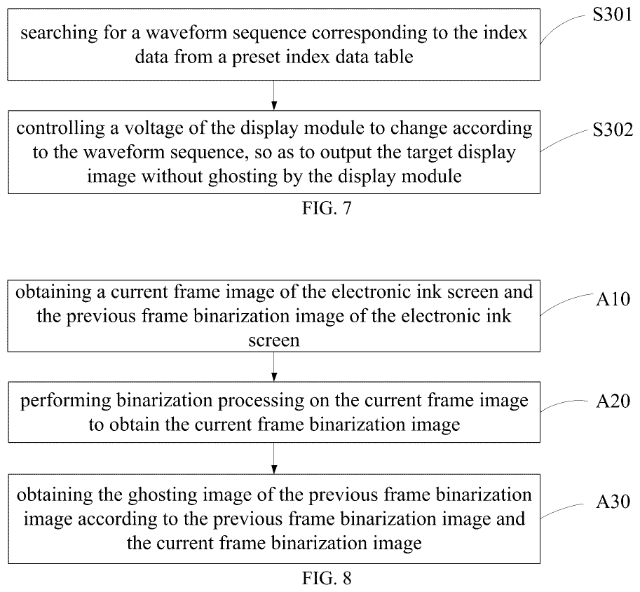

In a possible implementation, referring to FIG. 7, the electronic ink screen includes a display module, and the above-described step S30: outputting the target display image without the ghosting according to the index data, includes:

Step S301, searching for a waveform sequence corresponding to the index data from a preset index data table.

In this embodiment, the electronic ink screen equipment further pre-stores an index data table, the index data table includes combined data of one-to-one corresponding of multiple index data and multiple waveform sequences, and the electronic ink screen finds the waveform sequence corresponding to the index data according to the table.

Step S302, controlling a voltage of the display module to change according to the waveform sequence, so as to output the target display image without ghosting by the display module.

In this embodiment, the electronic ink screen equipment further includes a display module, which is configured to display the received image frame by frame. The electronic ink screen equipment controls the voltage of the display module to change according to the waveform sequence, so that it outputs the target display image without ghosting for display.

In this way, the electronic ink screen equipment determines the waveform sequence according to the index data obtained from the previous frame binarization image and the current frame merged image. Compared with the traditional waveform sequence, the waveform sequence determined in this embodiment adds the level change information of the ghosting image of the previous frame, so that the electronic ink screen equipment can automatically remove the ghosting when controlling the display module to refresh based on the waveform sequence.

Based on the above embodiment of the present application, referring to FIG. 8, in another embodiment of the present application, the same or similar contents as described above can be referred to the above introduction and will not be described in detail later. On this basis, before the above-described step S10: performing the image mergence on the current frame binarization image of the electronic ink screen and the ghosting image of the previous frame binarization image of the electronic ink screen, the method for removing the ghosting based on the electronic ink screen of the present application further includes:

Step A10, obtaining a current frame image of the electronic ink screen and the previous frame binarization image of the electronic ink screen.

Step A20, performing binarization processing on the current frame image to obtain the current frame binarization image.

In this embodiment, the electronic ink screen equipment obtains the current frame image and the previous frame binarization image, and then performs binarization processing on the current frame image to obtain the current frame binarization image. The binarization processing may specifically be an error diffusion algorithm, a mask algorithm, or an octree algorithm, etc., which is not specifically limited in this embodiment.

It should be noted that, in this embodiment, assuming that the current frame image is the Nth frame image and the previous frame image is the (N−1)th frame image, when the electronic ink screen equipment obtains the (N+1)th frame image, the Nth frame binarization image is the previous frame binarization image, that is, the current frame binarization image is the previous frame binarization image of the next frame image.

Step A30, obtaining the ghosting image of the previous frame binarization image according to the previous frame binarization image and the current frame binarization image.

In this embodiment, the electronic ink screen equipment performs corresponding image processing operations according to the previous frame binarization image and the current frame binarization image to obtain a ghosting image of the previous frame binarization image. The ghosting image is the ghosting that will appear when the traditional electronic ink screen equipment refreshes from the previous frame image to the current frame image.

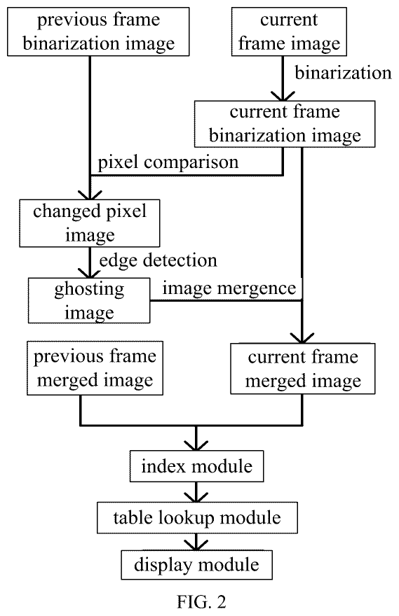

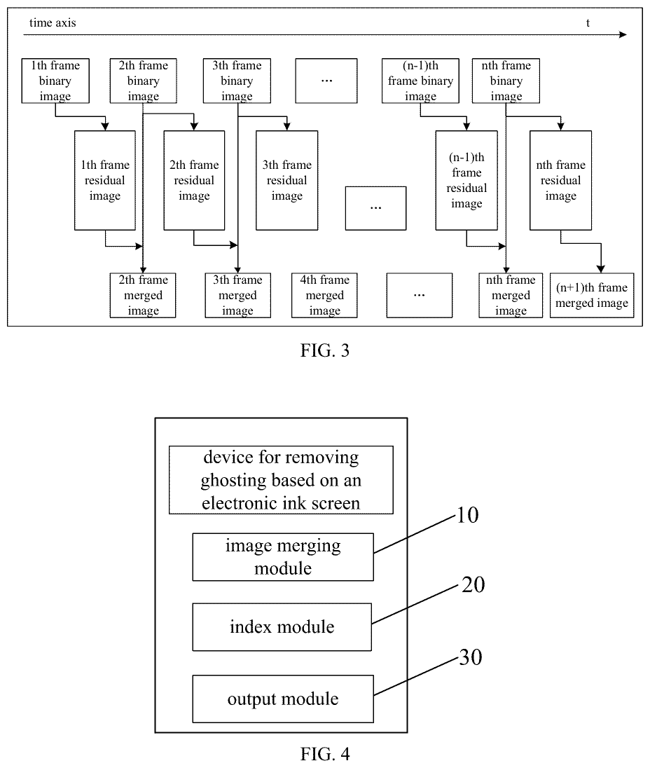

Exemplarily, in this embodiment, as shown in FIG. 2, the electronic ink screen equipment obtains the current frame image and the previous frame binarization image, then performs binarization processing on the current frame image to obtain the current frame binarization image, performs pixel comparison between the previous frame binarization image and the current frame binarization image to obtain the changed pixel image, performs edge detection on the changed pixel image to obtain the ghosting image, and then performs image mergence on the current frame binarization image and the ghosting image to obtain the current frame merged image. Specifically, the electronic ink screen equipment obtains and merges image frame by frame on the time axis as shown in FIG. 3. And then, the electronic ink screen equipment uses the index module again to performs pixel comparison between the previous frame merged image and the current frame merged image to obtain the index data, and searches the waveform sequence corresponding to the index data from the table lookup module, so as to output the target display image without ghosting in the display module.

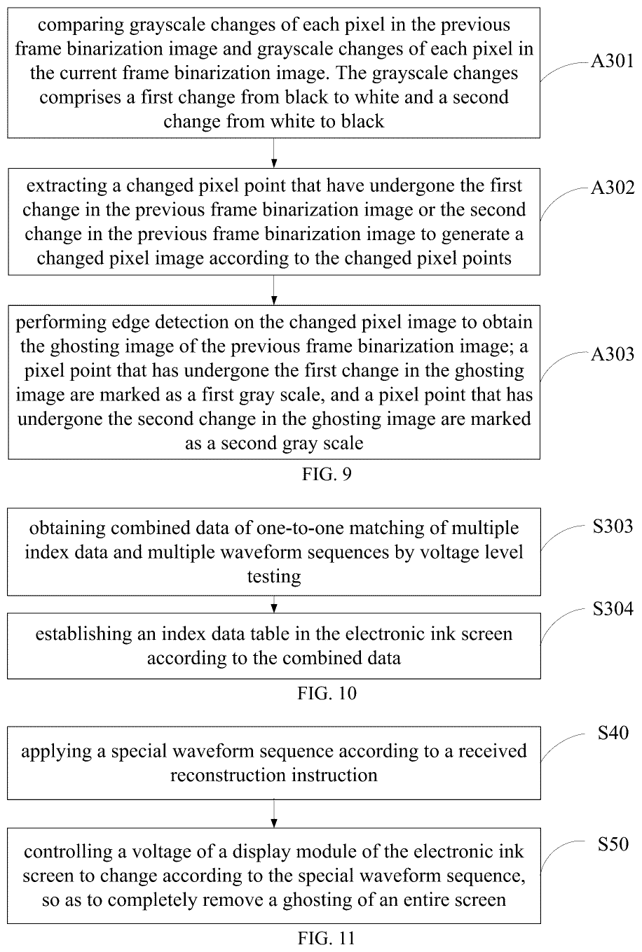

In a possible implementation, referring to FIG. 9, step A30 includes:

Step A301, comparing gray scale changes of each pixel in the previous frame binarization image and gray scale changes of each pixel in the current frame binarization image. The gray scale changes include a first change from black to white and a second change from white to black.

In this embodiment, the electronic ink screen equipment compares the gray scale change between each pixel point in the previous frame binarization image and the current frame binarization image. Since the binarization image only contains black pixel points and/or white pixel points, the gray scale change between each corresponding pixel point in the two images includes a first change from black to white and a second change from white to black. At present, there may be no change between the corresponding pixel points, that is, the black pixel point in the previous frame binarization image is still a black pixel point in the current frame binarization image, and the white pixel point in the previous frame binarization image is still a white pixel point in the current frame binarization image.

Step A302, extracting a changed pixel point that have undergone the first change in the previous frame binarization image or the second change in the previous frame binarization image to generate a changed pixel image according to the changed pixel points.

In this embodiment, the electronic ink screen equipment extracts all the changed pixel points that undergo the first change or the second change in the previous frame binarization image, and generates a changed pixel image from each of the extracted changed pixel points.

It should be noted that, in order to facilitate the distinction of the change trajectory of each pixel point in the changed pixel image, the pixel point where the first change occurs is marked as the first gray scale, and the pixel point where the second change occurs is marked as the second gray scale. Since the ghosting generated by the black pixel point is generally dark gray, and the ghosting generated by the white pixel point is generally light gray, in this embodiment, the value of the first gray scale is preferably the gray scale value corresponding to the dark gray, the value of the second gray scale is preferably the gray scale data corresponding to the light gray, and this mark can be regarded as the ghosting image mark of the electronic ink screen equipment.

Step A303, performing edge detection on the changed pixel image to obtain the ghosting image of the previous frame binarization image; a pixel point that has undergone the first change in the ghosting image are marked as a first gray scale, and a pixel point that has undergone the second change in the ghosting image are marked as a second gray scale.

In this embodiment, the electronic ink screen performs edge detection on the changed pixel image, and the algorithm that performing the edge detection may be a sobel operator or a Laplace operator, etc., so as to obtain the ghosting image of the previous frame binarization image. At this time, the ghosting image only includes the edge part with a large gradient of the color gradation change in the changed pixel image, and the edge part where the color gradation change changes from black to white is marked as the first gray scale, and the edge part where the color gradation change changes from white to black is marked as the second gray scale.

In a possible implementation, referring to FIG. 10, before the above-described step S301, the method for removing the ghosting based on the electronic ink screen of the present application further includes:

Step S303, obtaining combined data of one-to-one matching of multiple index data and multiple waveform sequences by voltage level testing.

Step S304, establishing an index data table in the electronic ink screen according to the combined data.

In this embodiment, each pixel point of the electronic ink screen display module is refreshed from black to white, or from white to black, just by adding positive electricity or negative electricity to both ends of the electrode and continuing for a period of time. Assuming that the duration for each power addition is a small frame t1, after adding N frames of valid frames, images with different gray scales can be obtained. Certainly, the duration N can be modified, which is specifically related to the process of the electronic ink screen and the temperature of the screen when screen is working. Usually, the refresh of the electronic ink screen display module has the following combinations:

| gray scale change | duration | changes in electrode voltage levels |
|---|---|---|
| black to white | N*t1 | waveform data sequence 1 |
| white to black | N*t1 | waveform data sequence 2 |
| black to black | N*t1 | waveform data sequence 3 |
| white to white | N*t1 | waveform data sequence 4 |

In edge detection, light gray and dark gray are introduced. Therefore, we can get black to white, black to light gray, black to dark gray, black to black, white to white, white to light gray, white to dark gray, white to black, dark gray to white, dark gray to light gray, dark gray to dark gray, dark gray to black, light gray to white, light gray to light gray, light gray to dark gray, light gray to black, which are a total of sixteen combinations. voltage level testing is performed for each of these sixteen combinations. According to the actual test results, the level changes of each of these sixteen combinations can be obtained. Establishing the index data table corresponding to the sixteen combinations, index data, and waveform sequence of level changes one by one, and the table is fixed in the equipment in the form of a file during the production phase of the electronic ink screen equipment.

It should be noted that in this embodiment, different models of electronic ink screen equipment may use different screens, so their index data tables are also different.

In a possible implementation, referring to FIG. 11, after the above-described step S30: outputting the target display image without the ghosting according to the index data, the method for removing the ghosting based on the electronic ink screen of the present application further includes:

Step S40, applying a special waveform sequence according to a received reconstruction instruction.

Step S50, controlling a voltage of a display module of the electronic ink screen to change according to the special waveform sequence, so as to completely remove a ghosting of an entire screen.

In this embodiment, in order to avoid aggravation of the ghosting of the electronic ink screen equipment after multiple refreshes, the electronic ink screen equipment can apply a special waveform sequence according to the received reconstruction instruction. The special waveform sequence can be configured to perform a full-screen refresh of the display module, and control the voltage of the display module to change according to the special waveform sequence, thereby reconstructing the picture plane of the display module, and completely removing any ghosting in the picture plane.

It should be noted that in this embodiment, the reconstruction instruction can be triggered by the user's touch operation on the electronic ink screen equipment, or the reconstruction instruction can also be preset for a certain time period or refresh number, and the electronic ink screen equipment will automatically trigger the reconstruction instruction, which is not specifically limited in this embodiment.

In this embodiment, by determining the ghosting image left by the previous frame image on the display interface of the current frame image, and using the actual gray scale value when the ghosting was generated to mark each pixel point in the ghosting image, and by constructing a waveform sequence, the electronic ink screen equipment refreshes the ghosting to white during normal refresh, thereby achieving the effect of automatically removing ghostings. Especially in the fast refresh mode of the electronic ink screen equipment, the ghosting of the display module caused by fast refresh can be greatly reduced, thus improving the display command of picture plane significantly.

Embodiments of the present application further provide a device for removing ghosting based on an electronic ink screen. Referring to FIG. 4, the device for removing the ghosting based on the electronic ink screen includes an image merging module 10, an index module 20 and an output module 30.

The image merging module 10 is configured to perform image mergence on a current frame binarization image of the electronic ink screen and a ghosting image of a previous frame binarization image of the electronic ink screen, and obtain a current frame merged image containing ghosting position information of a previous frame image.

The index module 20 is configured to perform pixel comparison operation on a previous frame merged image and the current frame merged image, and obtain index data; and

The output module 30 is configured to output a target display image without the ghosting according to the index data.

In an embodiment, the device for removing the ghosting based on the electronic ink screen further includes: an image acquisition module, a binarization processing module and a ghosting generation module.

The image acquisition module is configured to obtain a current frame image of the electronic ink screen and the previous frame binarization image of the electronic ink screen.

The binarization processing module is configured to perform binarization processing on the current frame image to obtain the current frame binarization image.

The ghosting generation module is configured to obtain the ghosting image of the previous frame binarization image according to the previous frame binarization image and the current frame binarization image.

In an embodiment, the ghosting generation module is further configured for:
comparing gray scale changes of each pixel in the previous frame binarization image and gray scale changes of each pixel in the current frame binarization image; the gray scale changes includes a first change from black to white and a second change from white to black;
extracting a changed pixel point that have undergone the first change in the previous frame binarization image or the second change in the previous frame binarization image to generate a changed pixel image according to the changed pixel points; and
performing edge detection on the changed pixel image to obtain the ghosting image of the previous frame binarization image; a pixel point that has undergone the first change in the ghosting image are marked as a first gray scale, and a pixel point that has undergone the second change in the ghosting image are marked as a second gray scale.

In an embodiment, the electronic ink screen includes a display module, and the output module 30 is further configured for:
searching for a waveform sequence corresponding to the index data from a preset index data table; and
controlling a voltage of the display module to change according to the waveform sequence, so as to output the target display image without ghosting by the display module.

In an embodiment, the device for removing the ghosting based on the electronic ink screen further includes:
an index data table establishment module, configured to obtain combined data of one-to-one matching of multiple index data and multiple waveform sequences by voltage level testing;
and establish an index data table in the electronic ink screen according to the combined data.

In an embodiment, the image merging module 10 is further configured for:
taking the current frame binarization image of the electronic ink screen and the ghosting image of the previous frame binarization image as an input image of a blending layer merging algorithm to perform the image mergence.

In an embodiment, the device for removing the ghosting based on the electronic ink screen further includes:
a picture plane reconstruction module, configured to apply a special waveform sequence according to a received reconstruction instruction; and control a voltage of a display module of the electronic ink screen to change according to the special waveform sequence, so as to completely remove a ghosting of an entire screen.

The device for removing the ghosting based on the electronic ink screen provided by the present application adopts the method for removing the ghosting based on the electronic ink screen as described above, and can automatically remove the ghosting when the electronic ink screen is refreshed. Compared with the prior art, the beneficial effects of the device for removing the ghosting based on the electronic ink screen provided by the embodiment of the present application are the same as the beneficial effects of the method for removing the ghosting based on the electronic ink screen provided by the embodiment as described above, and the other technical features of the device for removing the ghosting based on the electronic ink screen are the same as the features disclosed in the method of the previous embodiment, which will not be repeated here.

The embodiment of the present application provides a terminal equipment, the terminal equipment includes: at least one processor; and a memory connected to the at least one processor in communication. The memory stores an instruction executable by the at least one processor, the instruction is executed by the at least one processor to cause the at least one processor to execute the method for removing the ghosting based on the electronic ink screen in the embodiments as described above.

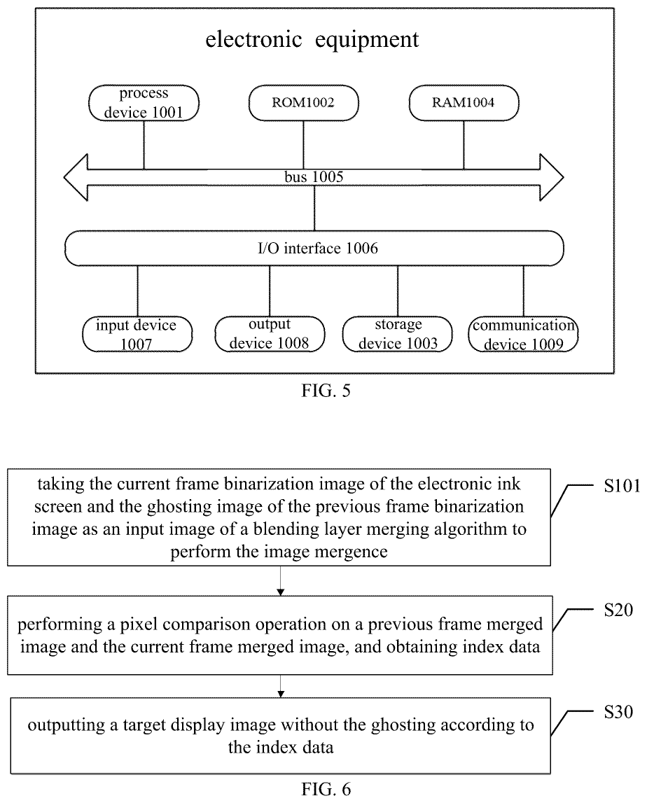

Referring to FIG. 5 below, which shows a schematic view of a structure of a terminal equipment suitable for implementing the embodiment of the present application. The terminal equipment in the embodiment of the present application may include but is not limited to electronic ink screen equipment such as electronic ink screen tablets, electronic ink screen displays, electronic ink screen readers, etc. The terminal equipment shown in FIG. 5 is only an example and should not bring any limitation to the functions and scope of use of the embodiment of the present application.

As shown in FIG. 5, the terminal equipment may include a process device 1001 (that is, a central processing unit, a graphics processor, etc.), which can perform various appropriate actions and processes according to a program stored in a read-only memory (ROM) 1002 or a program loaded from a storage device 1003 to a random access memory (RAM) 1004. In RAM 1004, various programs and data required for the operation of the terminal equipment are further stored. The process device 1001, ROM 1002, and RAM 1004 are connected to each other via a bus 1005. An input/output (I/O) interface 1006 is also connected to the bus. Typically, the following systems can be connected to the I/O interface 1006: an input device 1007 including, for example, a touch screen, a touchpad, a keyboard, a mouse, an image sensor, a microphone, an accelerometer, a gyroscope, etc.; an output device 1008 including, for example, a liquid crystal display (LCD), a speaker, a vibrator, etc.; a storage device 1003 including, for example, a magnetic tape, a hard disk, etc.; and a communication device 1009. The communication device 1009 can allow the terminal equipment to communicate with other equipment wirelessly or wired to exchange data. Although the figure shows terminal equipment with various systems, it should be understood that it is not required to implement or have all the systems shown. More or fewer systems may be implemented or have alternatively.

In particular, according to an embodiment of the present application, the process described above with reference to the flowchart can be implemented as a computer software program. For example, an embodiment of the present application includes a computer program product, which includes a computer program carried on a computer-readable medium, and the computer program contains program code for executing the method shown in the flowchart. In such an embodiment, the computer program can be downloaded and installed from the network by the communication device, or installed from the storage device 1003, or installed from the ROM 1002. When the computer program is executed by the process device 1001, the above-described functions defined in the method of the embodiment of the present application are executed.

The terminal equipment provided by the present application adopts the method for removing the ghosting based on the electronic ink screen in the above-described embodiment, and can automatically remove the ghosting when the electronic ink screen is refreshed. Compared with the prior art, the beneficial effects of the terminal equipment provided by the embodiment of the present application are the same as the beneficial effects of the method for removing the ghosting based on the electronic ink screen provided by the above-described embodiment, and other technical features in the terminal equipment are the same as the features disclosed in the method of the previous embodiment, which are not repeated here.

It should be understood that the various parts of the present application can be implemented by hardware, software, firmware or a combination thereof. In the description of the above-described embodiment, specific features, structures, materials or characteristics can be combined in any one or more embodiments or examples in a suitable manner.

The above description is only a specific embodiment of the present application, but the scope of the present application is not limited thereto. Any technician familiar with the technical field can easily think of changes or replacements within the technical scope disclosed by the present application, which should be covered within the scope of the present application. Therefore, the scope of the present application shall be subject to the scope of the claims.

The embodiment of the present application provides a computer-readable storage medium having computer-readable program instructions stored thereon, and the computer-readable program instructions are configured to execute the method for removing the ghosting based on the electronic ink screen in the above embodiment as described above.

The computer-readable storage medium provided in the embodiment of the present application can be, for example, a Universal Serial Bus (USB) flash drive, but is not limited to electrical, magnetic, optical, electromagnetic, infrared, or semiconductor systems or devices, or any combination of the above. More specific examples of computer-readable storage medium can include, but are not limited to: an electrical connection with one or more wires, a portable computer disk, a hard disk, a random access memory (RAM), a read-only memory (ROM), an erasable programmable read-only memory (EPROM: Erasable Programmable Read Only Memory or flash memory), an optical fiber, a portable compact disk read-only memory (CD-ROM), an optical storage device, a magnetic storage device, or any suitable combination of the above as described above. In this embodiment, the computer-readable storage medium may be any tangible medium containing or storing a program that may be used by or in conjunction with an instruction execution system, or device. The program code contained on the computer-readable storage medium may be transmitted using any appropriate medium, including but not limited to: wires, optical cables, RF (Radio Frequency), etc., or any suitable combination as described above.

The computer-readable storage medium as described above may be included in the terminal equipment, or may exist independently and not be assembled in the terminal equipment.

The computer-readable storage medium as described above carries one or more programs. When the one or more programs as described above are executed by the terminal equipment, the terminal equipment is caused to: perform image mergence on a current frame binarization image of the electronic ink screen and a ghosting image of a previous frame binarization image of the electronic ink screen, and obtain a current frame merged image containing ghosting position information of a previous frame image; perform a pixel comparison operation on a previous frame merged image and the current frame merged image, and obtain index data; and output a target display image without the ghosting according to the index data.

Computer program code configured for performing the operations of the present application may be written in one or more programming languages or a combination thereof, including object-oriented programming languages such as Java, Smalltalk, C++, and further include conventional procedural programming languages such as “C” language or similar programming languages. The program code may be executed entirely on the user's computer, or may be executed partially on the user's computer, or may be executed as a separate software package, or may be executed partially on the user's computer and partially on a remote computer, or may be executed entirely on a remote computer or server. In situations involving remote computers, the remote computer may be connected to the user's computer by any type of network, including a local area network (LAN) or a wide area network (WAN), or may be connected to an external computer (that is, use an Internet Service Provider to connect via the Internet).

The flowcharts and block diagrams in the accompanying drawings illustrate the possible architecture, functions, and operations of the systems, methods, and computer program products according to various embodiments of the present application. In this regard, each square frame in a flowchart or block diagram may represent a module, a program segment, or a portion of a code. The module, the program segment, or the portion of the code contains one or more executable instructions for implementing a specified logical function. It should also be noted that in some alternative implementations, the functions marked in the box may also occur in a different order than that marked in the accompanying drawings. For example, two square frames represented in succession may actually be executed substantially in parallel, and they may sometimes be executed in the opposite order, depending on the functions involved. It should also be noted that each square frame in a block diagram and/or flowchart, and a combination of square frames in a block diagram and/or flowchart, may be implemented with a dedicated hardware-based system that performs a specified function or operation, or may be implemented with a combination of dedicated hardware and computer instructions.

The modules described in the embodiments of the present application may be implemented in software or in hardware. The name of the module does not constitute a limitation on the unit itself in certain situations.

The readable storage medium provided by the present application is a computer-readable storage medium, which stores computer-readable program instructions for executing the method for removing the ghosting based on the electronic ink screen as described above, and can automatically remove the ghosting when the electronic ink screen is refreshed. Compared with the prior art, the beneficial effects of the computer-readable storage medium provided in the embodiment of the present application are the same as the beneficial effects of the method for removing the ghosting based on the electronic ink screen as described above, and are not described in detail here.

The embodiment of the present application further provides a computer program product including a computer program, the computer program implements the steps of the method for removing the ghosting based on the electronic ink screen as described above when the computer program is executed by a processor.

The computer program product provided in the present application can automatically remove the ghosting when the electronic ink screen is refreshed. Compared with the prior art, the beneficial effects of the computer program product provided in the embodiment of the present application are the same as the beneficial effects of the method for removing the ghosting based on the electronic ink screen as described above, and will not be repeated here.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A method for removing ghosting based on an electronic ink screen, comprising:
performing image mergence on a current frame binarization image of the electronic ink screen and a ghosting image of a previous frame binarization image of the electronic ink screen, and obtaining a current frame merged image containing ghosting position information of a previous frame image;
performing a pixel comparison operation on a previous frame merged image and the current frame merged image, and obtaining index data; and
outputting a target display image without the ghosting according to the index data.

2. The method according to claim 1, wherein before the performing the image mergence on the current frame binarization image of the electronic ink screen and the ghosting image of the previous frame binarization image of the electronic ink screen, the method further comprises:
obtaining a current frame image of the electronic ink screen and the previous frame binarization image of the electronic ink screen;
performing binarization processing on the current frame image to obtain the current frame binarization image; and
obtaining the ghosting image of the previous frame binarization image according to the previous frame binarization image and the current frame binarization image.

3. The method according to claim 2, wherein the obtaining the ghosting image of the previous frame binarization image according to the previous frame binarization image and the current frame binarization image comprises:
comparing gray scale changes of each pixel in the previous frame binarization image and gray scale changes of each pixel in the current frame binarization image; wherein the gray scale changes comprises a first change from black to white and a second change from white to black;
extracting a changed pixel point that have undergone the first change in the previous frame binarization image or the second change in the previous frame binarization image to generate a changed pixel image according to the changed pixel points; and
performing edge detection on the changed pixel image to obtain the ghosting image of the previous frame binarization image; wherein a pixel point that has undergone the first change in the ghosting image are marked as a first gray scale, and a pixel point that has undergone the second change in the ghosting image are marked as a second gray scale.

4. The method according to claim 1, wherein the electronic ink screen comprises a display module, and the outputting the target display image without the ghosting according to the index data comprises:
searching for a waveform sequence corresponding to the index data from a preset index data table; and
controlling a voltage of the display module to change according to the waveform sequence, so as to output the target display image without ghosting by the display module.

5. The method according to claim 4, wherein before the searching for the waveform sequence corresponding to the index data from the preset index data table, the method further comprises:
obtaining combined data of one-to-one matching of multiple index data and multiple waveform sequences by voltage level testing; and
establishing an index data table in the electronic ink screen according to the combined data.

6. The method according to claim 1, wherein the performing the image mergence on the current frame binarization image of the electronic ink screen and the ghosting image of the previous frame binarization image of the electronic ink screen comprises:
taking the current frame binarization image of the electronic ink screen and the ghosting image of the previous frame binarization image as an input image of a blending layer merging algorithm to perform the image mergence.

7. The method according to claim 1, wherein after the outputting the target display image without the ghosting according to the index data, the method further comprises:
applying a special waveform sequence according to a received reconstruction instruction; and
controlling a voltage of a display module of the electronic ink screen to change according to the special waveform sequence, so as to completely remove a ghosting of an entire screen.

8. A device for removing ghosting based on an electronic ink screen, comprising:
an image merging module, configured to perform image mergence on a current frame binarization image of the electronic ink screen and a ghosting image of a previous frame binarization image of the electronic ink screen, and obtain a current frame merged image containing ghosting position information of a previous frame image;
an index module, configured to perform a pixel comparison operation on a previous frame merged image and the current frame merged image, and obtain index data; and
an output module, configured to output a target display image without the ghosting according to the index data.

9. A terminal equipment, comprising:
at least one processor; and
a memory connected to the at least one processor in communication;
wherein the memory stores an instruction executable by the at least one processor, the instruction is executed by the at least one processor to cause the at least one processor to execute the method for removing the ghosting based on the electronic ink screen according to claim 1.

10. A non-transitory computer-readable storage medium, wherein the non-transitory computer-readable storage medium stores a program for implementing a method for removing ghosting based on an electronic ink screen, and the program for implementing the method for removing the ghosting based on the electronic ink screen is executed by a processor to implement the method for removing the ghosting based on the electronic ink screen according to claim 1.
